(19) United States
(12) Patent Application Publication
(10) Pub. No.: US 2020/0173415 A1
(43) Pub. Date: Jun. 4, 2020

(54) DEPRESSURIZATION DEVICE OF INTERNAL COMBUSTION ENGINE

(71) Applicant: KWANG YANG MOTOR CO., LTD., KAOHSIUNG CITY (TW)

(72) Inventor: Jiun-Jie Shin, KAOHSIUNG CITY (TW)

(21) Appl. No.: 16/554,523

(22) Filed: Aug. 28, 2019

(30) Foreign Application Priority Data
Nov. 30, 2018 (TW) 107216307

(51) Int. Cl. F02N 19/00; F01L 1/34; F01L 1/18

(52) U.S. Cl. CPC F02N 19/004; F01L 2009/0453; F01L 1/18; F01L 1/34

(57) ABSTRACT

A depressurization device is mounted on a camshaft that includes an exhaust cam operable to push an exhaust rocker arm. The depressurization device includes a base disc mounted on the camshaft and adjacent to the exhaust cam, a counterweight swing arm coupled to the base disc, an elastic element arranged between the base disc and the counterweight swing arm, a depressurization cam element coupled to the exhaust cam and drivable by the counterweight swing arm, and an axle bar extending through the base disc and the counterweight swing arm. The depressurization cam element includes a driving section, a depressurization cam section, and a rotary shaft section. The depressurization cam element is drivable by the counterweight swing arm to rotate by an angle. The depressurization cam section includes an arc portion and first and second cut-off portions arranged at a side opposite to the arc portion.

### TECHNICAL FIELD OF THE INVENTION

The present invention relates to a depressurization device of an internal combustion engine, and more particularly to a depressurization device of an internal combustion engine that enables initiation of an effect of depressurization at a low rotational speed of the internal combustion engine, so as to ease starting and control a starting rotational speed, and to allow the internal combustion engine to depressurize at a preset rotational speed to thereby enhance a depressurization effect and universality of application of the depressurization device.

### DESCRIPTION OF THE PRIOR ART

As shown in FIG. 1, when an internal combustion engine 1 is started, to prevent a resistance generated by a piston 11 moving upward from a bottom dead center in the internal combustion engine 1 from getting excessively large, a depressurization device 14 is generally arranged on a camshaft 13 inside a cylinder head 12.

The depressurization device 14 is arranged beside an exhaust cam 131 of the camshaft 13, so that the depressurization device 14 pushes against an exhaust rocker arm 15 at the starting of the internal combustion engine 1, and the exhaust rocker arm 15 is so pushed by the depressurization device 14 makes an exhaust valve (not shown in the drawings) to open by a slight degree. As such, when the internal combustion engine 1 is started, the piston 11, when moving upward from the bottom dead center, generates an air pressure in the combustion chamber 16, and the air pressure generated by the upward movement of the piston 11 is released through the exhaust valve that is set in a slightly open condition, and thus, the resistance induced by the upward movement of the piston 11 from the bottom dead center is reduced so as to ease the starting of the internal combustion engine 1.

Although the internal combustion engine 1 can reduce the resistance induced by the upward movement of piston 11 from the bottom dead center by arranging a depressurization device 14 at one side of the camshaft 13, it is still a challenge of the internal combustion engine manufacturers to ensure operability of the depressurization device 14 and to realize universal applicability of the depressurization device 14 to internal combustion engines 1 of various engine displacements.

### SUMMARY OF THE INVENTION

The primary objective of the present invention is to provide a depressurization device of an internal combustion engine, which helps overcome the deficiency of insufficient universality of known depressurization devices of internal combustion engines.

For such an objective, the primary technical solution of the present invention provided in claim 1 is to provide a depressurization device of an internal combustion engine, wherein the depressurization device is mounted on a camshaft. The camshaft includes an intake cam and an exhaust cam. The exhaust cam includes a raised section and a base circle section. The exhaust cam is operable to push an exhaust rocker arm. The depressurization device comprises a base disc that is mounted on the camshaft and adjacent to the exhaust cam, a counterweight swing arm coupled to the base disc, an elastic element that is arranged between and hooks on the base disc and the counterweight swing arm, a depressurization cam element that is coupled to the exhaust cam and is drivable by the counterweight swing arm, and an axle bar that extends through and is received in the base disc and the counterweight swing arm. The depressurization cam element comprises a driving section, a depressurization cam section, and a rotary shaft section that are arranged in sequence in a direction from the counterweight swing arm toward the exhaust cam. The depressurization cam element is drivable by the counterweight swing arm to rotate by an angle. The depressurization cam section includes an arc portion and a first cut-off portion and a second cut-off portion that are arranged at a side that is opposite to the arc portion.

For such an objective, the primary technical solution of the present invention provided in claim 2 is to provide a depressurization device of an internal combustion engine, wherein the depressurization cam section includes the arc portion and a third cut-off portion located between the first cut-off portion and the second cut-off portion that are arranged at the side opposite to the arc portion.

For such an objective, the primary technical solution of the present invention provided in claim 3 is to provide a depressurization device of an internal combustion engine, wherein the rotary shaft section of the depressurization cam element is formed with a lubricant accommodation part that has a reduced diameter.

For such an objective, the primary technical solution of the present invention provided in claim 4 is to provide a depressurization device of an internal combustion engine, wherein, as viewed in a radial direction, the depressurization cam section is located outside a surface wide of the exhaust cam and is arranged in a parallel manner.

For such an objective, the primary technical solution of the present invention provided in claim 5 is to provide a depressurization device of an internal combustion engine, wherein a rotation center of the depressurization cam section and a rotation center of the exhaust cam are shifted away from each other and are arranged parallel.

For such an objective, the primary technical solution of the present invention provided in claim 6 is to provide a depressurization device of an internal combustion engine, wherein an outer edge of the arc portion projects outward beyond an outer edge of the base circle section of the exhaust cam by a height that is not greater than 0.9 mm.

For such an objective, the primary technical solution of the present invention provided in claim 7 is to provide a depressurization device of an internal combustion engine, wherein the outer edge of the arc portion projects outward beyond the outer edge of the base circle section of the exhaust cam by a height of approximately 0.1 mm to 0.8 mm.

For such an objective, the primary technical solution of the present invention provided in claim 8 is to provide a depressurization device of an internal combustion engine, wherein the outer edge of the arc portion projects outward beyond the outer edge of the base circle section of the exhaust cam by a height of approximately between 0.6 mm and 0.8 mm.

For such an objective, the primary technical solution of the present invention provided in claim 9 is to provide a depressurization device of an internal combustion engine, wherein a length from an exhaust rocker arm pivot center of the exhaust rocker arm to a pushing roller rotation center is less than a length from the exhaust rocker arm pivot center to a pushing peg center.

For such an objective, the primary technical solution of the present invention provided in claim 10 is to provide a depressurization device of an internal combustion engine, wherein the base disc is formed as being integrally combined with the camshaft and is located adjacent to the exhaust cam; and the base disc is of a sector form.

For such an objective, the primary technical solution of the present invention provided in claim 11 is to provide a depressurization device of an internal combustion engine, wherein, as viewed in a radial direction, the depressurization cam section is located outside a surface width of the exhaust cam and is arranged in a parallel manner; the exhaust rocker arm is provided, at an end thereof, with the pushing peg.

An efficacy that the technical solution of the present invention defined in claim 1 can achieve is that an effect of depressurization can be initiated even at a low rotational speed of the internal combustion engine to therefore ease starting and control a rotational speed for starting, and the internal combustion engine is allowed to depressurize at a preset rotational speed to thereby enhance the effectiveness and universality of the depressurization device.

An efficacy that the technical solution of the present invention defined in claim 2 can achieve is that a height between the opposite sides of the arc portion is effectively reduced to thereby enhance the effectiveness and universality of the depressurization device.

An efficacy that the technical solution of the present invention defined in claim 3 can achieve is that a resistance against rotation of the depressurization cam element caused by oil in case that the oil is excessively thick can be reduced to thereby ensure rotatability of the depressurization cam element.

An efficacy that the technical solution of the present invention defined in claim 4 can achieve is that the service life of the exhaust cam can be enhanced.

An efficacy that the technical solution of the present invention defined in claim 5 can achieve is that the service life of the exhaust cam can be enhanced.

An efficacy that the technical solution of the present invention defined in claim 6 can achieve is that an effect of depressurization and an effect of noise reduction of the depressurization device can be enhanced.

An efficacy that the technical solution of the present invention defined in claim 7 can achieve is that the depressurization device has a bettered effect of depressurization.

An efficacy that the technical solution of the present invention defined in claim 8 can achieve is that the depressurization device has a bettered effect of noise reduction.

An efficacy that the technical solution of the present invention defined in claim 9 can achieve is that an effect of the exhaust rocker arm pushing against the exhaust valve can be enhanced.

An efficacy that the technical solution of the present invention defined in claim 10 can achieve is that the overall weight of the base disc is reduced and assembling of the depressurization device is eased.

An efficacy that the technical solution of the present invention defined in claim 11 can achieve is that the service life of the exhaust cam is enhanced and the effectiveness and universality of the depressurization device are improved.

### BRIEF DESCRIPTION OF THE DRAWINGS

FIG. 1 is a schematic view showing a known depressurization device of an internal combustion engine.

FIG. 2 is a schematic view showing a depressurization device of an internal combustion engine according to the present invention.

FIG. 3 is an exploded view showing the depressurization device of the internal combustion engine according to the present invention;

FIG. 4 shows the depressurization device of the internal combustion engine according to the present invention in an assembled form.

FIG. 5 shows another embodiment of a depressurization cam element of the depressurization device according to the present invention.

FIG. 6 is a schematic view illustrating a depressurized state of the depressurization device of the internal combustion engine according to the present invention;

FIG. 7 is a schematic view illustrating a non-depressurized state of the depressurization device of the internal combustion engine according to the present invention; and

FIGS. 8 and 9 are schematic views illustrating an operation of the depressurization device of the internal combustion engine according to the present invention and an exhaust rocker arm.

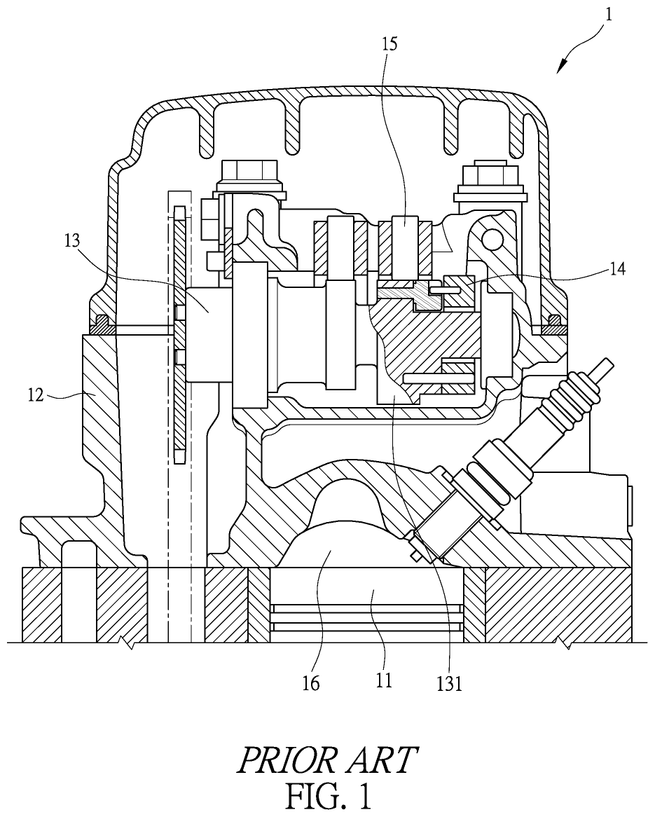

### DETAILED DESCRIPTION OF THE PREFERRED EMBODIMENT

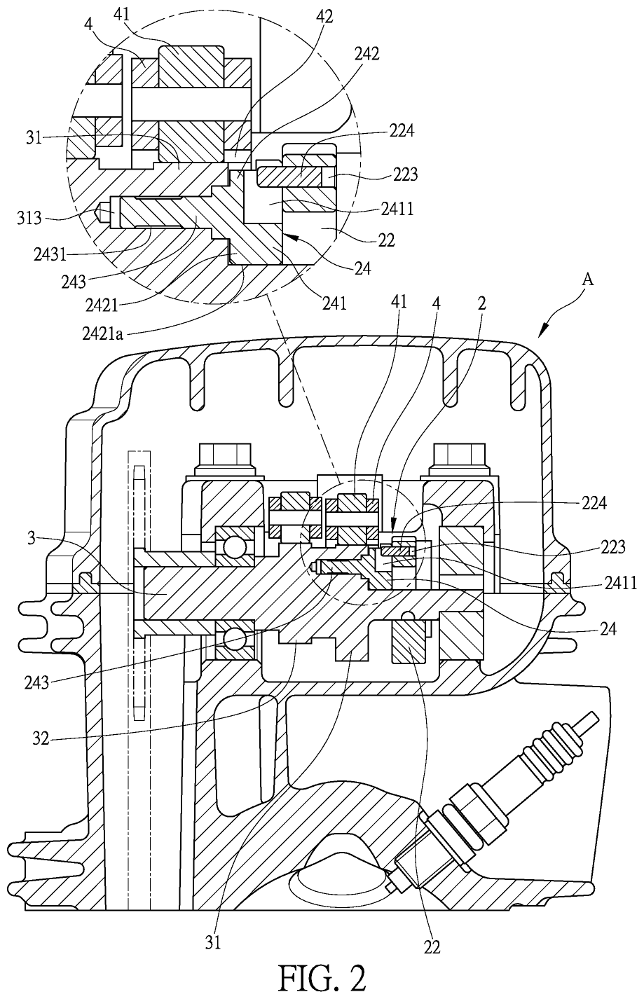

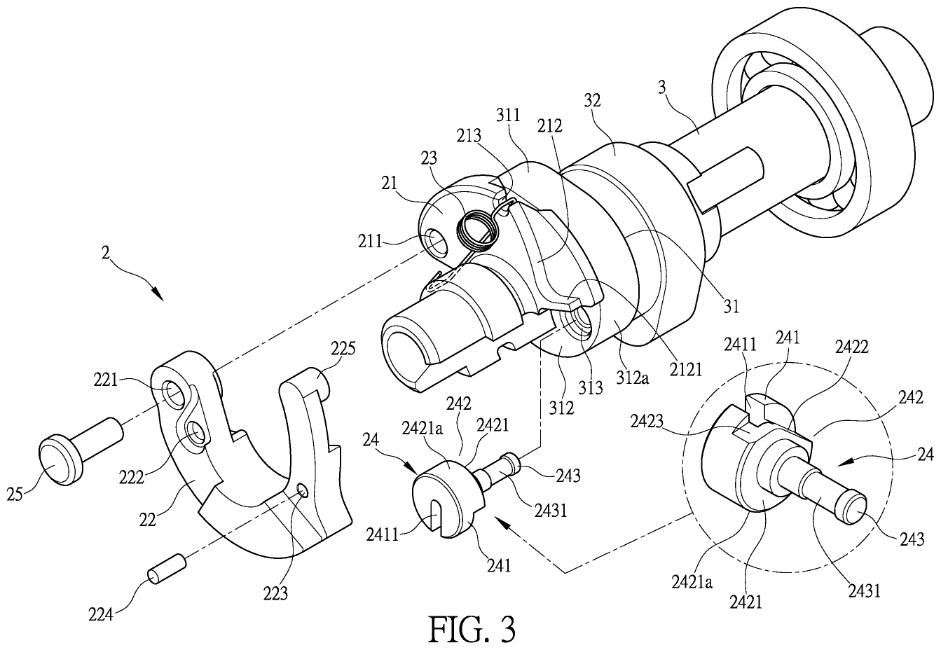

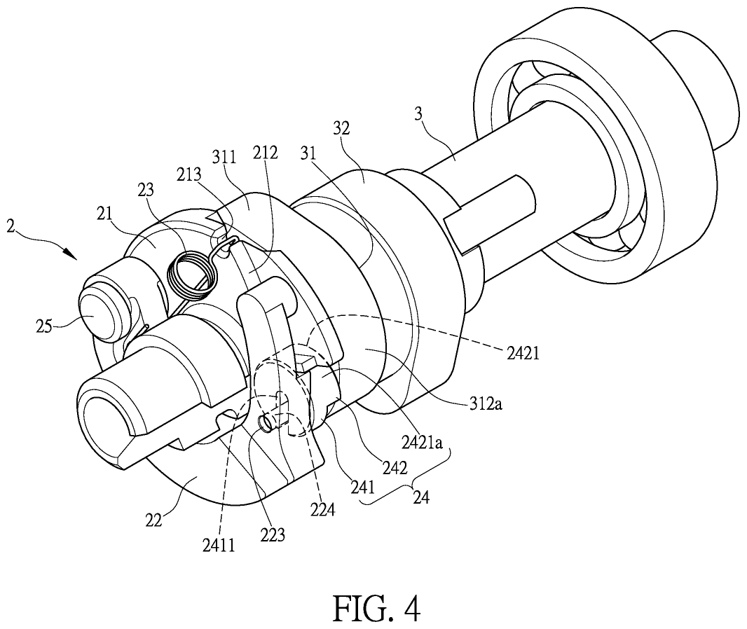

Firstly, referring to FIGS. 2, 3, and 4, the present invention provides a depressurization device of an internal combustion engine. The depressurization device 2 is mounted on a camshaft 3. The camshaft 3 is provided thereon with an exhaust cam 31 and an intake cam 32, and the depressurization device 2 is arranged adjacent to the exhaust cam 31 of the camshaft 3. The depressurization device 2 comprises a base disc 21, a counterweight swing arm 22, an elastic element 23, a depressurization cam element 24, and an axle bar 25.

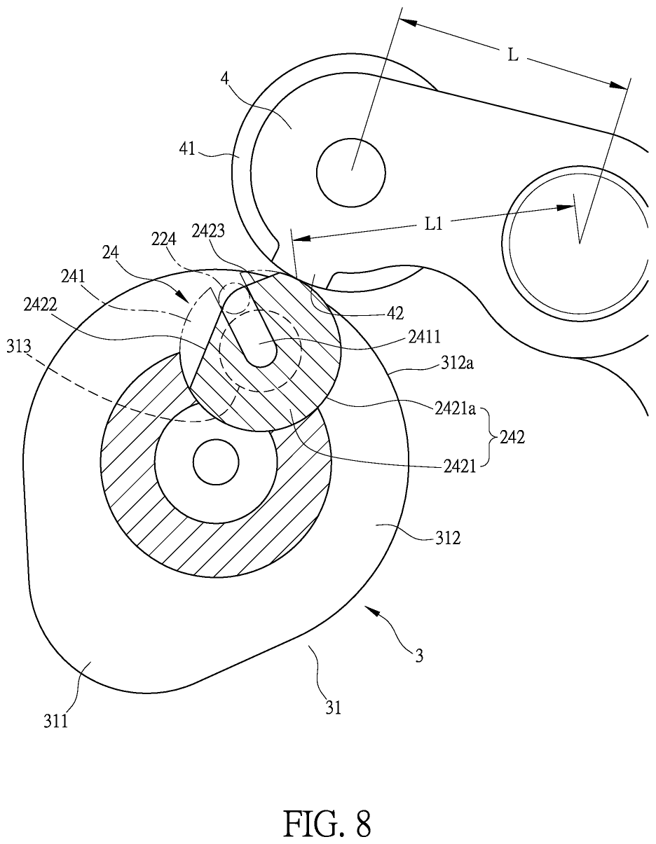

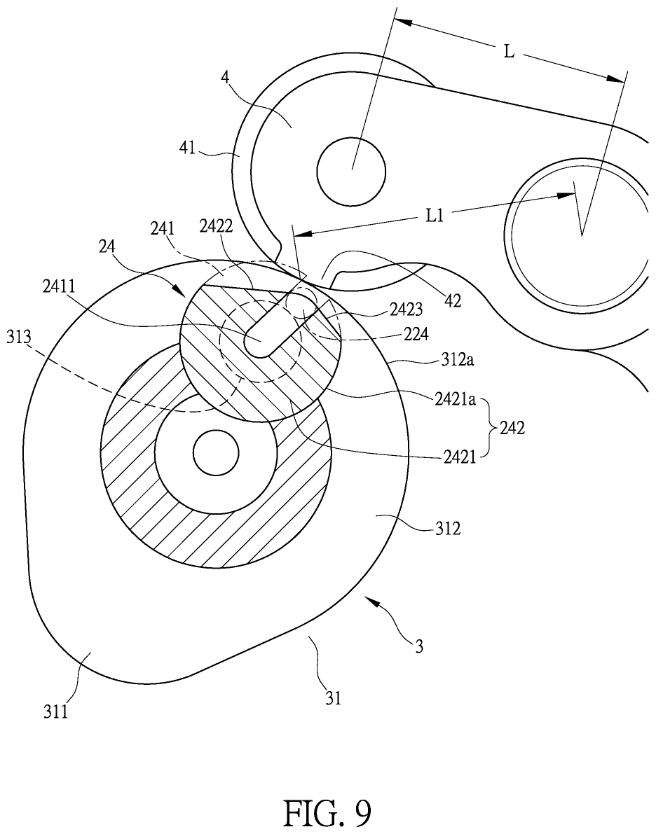

As shown in FIGS. 2, 3, 4, 8, and 9, the exhaust cam 31 is provided with an insertion hole 313 that is formed in a base circle section 312 that is at a side opposite to a raised section 311. The insertion hole 313 has an opening facing in a direction toward the depressurization device 2. Since the insertion hole 313 is arranged inboard an outer circumference of the exhaust cam 31, the base circle section 312 of the exhaust cam 31 may maintain a complete outer circumference. The exhaust cam 31 is operable to push an exhaust rocker arm 4. The exhaust rocker arm 4 is provided, at an end thereof, with a pushing roller 41. The exhaust rocker arm 4 is provided with a pushing peg 42 projecting from a lateral side of an end thereof. The exhaust rocker arm 4 is operable to push an exhaust valve (not shown in the drawings) for opening the valve. Further, a length L from an exhaust rocker arm pivot center of the exhaust rocker arm 4 to a pushing roller rotation center is less than a length L1 from the exhaust rocker arm pivot center to a pushing peg center, so that an effect of the exhaust rocker arm 4 pushing the exhaust valve can be enhanced.

As shown in FIGS. 2, 3, and 4, the base disc 21 is generally of a sector form, and the sector form of the base disc 21 does not exceed 180 degrees. The base disc 21 is formed, in an integrally-formed manner, on the camshaft 3, or is alternatively made as a separate part that is put in tight fitting engagement with the camshaft 3, so that the base disc 21 is adjacent to the exhaust cam 31; or more specifically, the base disc 21 is arranged distant from the intake cam 32 and is located beside the exhaust cam 31, meaning the intake cam 32, the exhaust cam 31, and the base disc 21 are arranged in such an order on the camshaft 3. The base disc 21 is formed with an axle hole 211, and is also provided, at an end opposite to the axle hole 211, with a position-limiting slide chute 212 that is formed in a height-differing manner. The position-limiting slide chute 212 includes a stop portion 2121, which is arranged in an upward raised manner, at an end that is distant from the axle hole 211. The base disc 21 is provided with a hooking engagement portion 213 between the axle hole 211 and the position-limiting slide chute 212, and the hooking engagement portion 213 may receive an end of the elastic element 23 therein for hooking thereto.

As shown in FIGS. 2, 3, and 4, the counterweight swing arm 22 is an arc body that is of a generally U shape. The counterweight swing arm 22 has a pivoting hole 221 formed in an end thereof. The pivoting hole 221 corresponds to the axle hole 211 of the base disc 21, so that the counterweight swing arm 22 can be mounted by having an axle bar 25 extending through the pivoting hole 221 and the axle hole 211 of the base disc 21 to have the counterweight swing arm 22 pivotally mounted to the base disc 21 and to swing or oscillate about a swing center defined by the axle bar 25. The counterweight swing arm 22 is formed with a hooking hole 222 at a location adjacent to the pivoting hole 221. The hooking hole 222 receives an end of the elastic element 23 therein for hooking thereto, and specifically speaking, an end of the elastic element 23 is arranged to hook on the hooking engagement portion 213 of the base disc 21 and an opposite end hooks on the hooking hole 222. The counterweight swing arm 22 is provided, at an end opposite to the hooking hole 222, with a through aperture 223 that extends through the counterweight swing arm 22. The through aperture 223 receives a coupling pin 224 to insert therein. The counterweight swing arm 22 is provided, at a location above the through aperture 223, with a position-limiting block 225 that is arranged to project in a direction toward the base disc 21. The position-limiting block 225 is constrained in the position-limiting slide chute 212 of the base disc 21 to do constraining sliding movement, and specifically speaking, when the counterweight swing arm 22 is driven by the camshaft 3 to generate a centrifugal force and swing or oscillate, the counterweight swing arm 22 is constrained by the constraining sliding movement of the position-limiting block 225 in the position-limiting slide chute 212 of the base disc 21 so as to constrain a swing range of the counterweight swing arm 22.

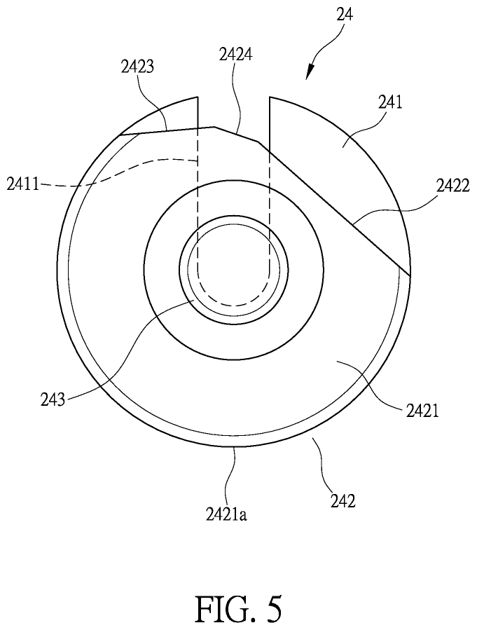

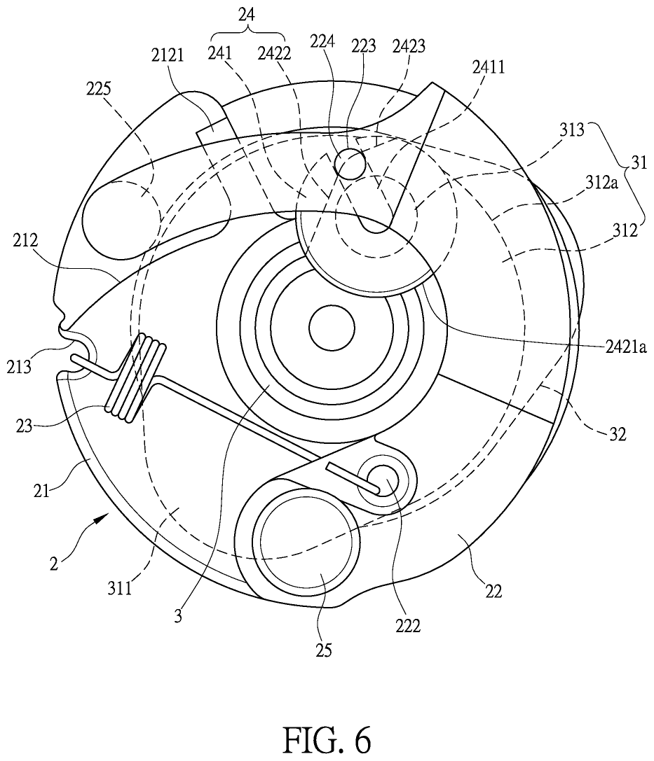

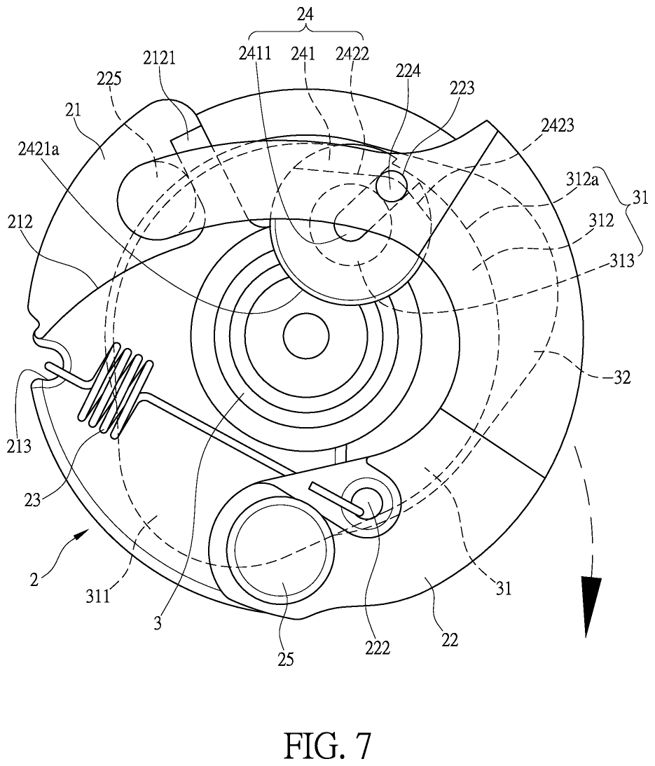

As shown in FIGS. 2, 3, 4, 5, 6, 7, 8, and 9, the depressurization cam element 24 includes a driving section 241, a depressurization cam section 242, and a rotary shaft section 243 that are arranged in sequence in a direction from the counterweight swing arm 22 toward the exhaust cam 31. The driving section 241 is formed, through recessing, a fitting trough 2411 that is generally of a U shape. The fitting trough 2411 receives the coupling pin 224 that inserted in the through aperture 223 of the counterweight swing arm 22, so that when the counterweight swing arm 22, after swinging, is returned by a spring force of the elastic element 23 back to the original position, the counterweight swing arm 22 may cause the depressurization cam element 24 to rotate an angle by means of the coupling pin 224. When viewed in a radial direction, the depressurization cam section 242 is located outside a surface wide of the exhaust cam 31 and is arranged in a parallel manner. A rotation center of the depressurization cam section 242 and a rotation center of the exhaust cam 31 are shifted away from each other and are arranged parallel. The depressurization cam section 242 includes an arc portion 2421 and a first cut-off portion 2422 and a second cut-off portion 2423 that are arranged at an side that is opposite to the arc portion 2421. An outer edge 2421a of the arc portion 2421 projects outward beyond an outer edge 312a of the base circle section 312 of the exhaust cam 31 by approximately 0.1 mm to 0.9 mm. The outer edge 2421a of the arc portion 2421 is arranged to receive the pushing peg 42 of the exhaust rocker arm 4 to contact therewith for pushing, so that before the exhaust cam 31 moves into pushing engagement with the exhaust rocker arm 4, the exhaust rocker arm 4 functions to make the exhaust valve to open for a small degree, wherein empirical tests carried out by the applicant reveal the effect of depressurization becomes best at the time point when the outer edge 2421a of the arc portion 2421 gets projecting outward beyond the outer edge 312a of the base circle section 312 of the exhaust cam 31 by approximately 0.1 mm to 0.8 mm; and the effect of reducing noise caused by the pushing engagement is best when the outer edge 2421a of the arc portion 2421 projects outward beyond the outer edge 312a of the base circle section 312 of the exhaust cam 31 by approximately 0.6 mm to 0.8 mm. The depressurization cam section 242 is further provided with a third cut-off portion 2424 between the first cut-off portion 2422 and the second cut-off portion 2423 in order to effectively reduce a height between the opposite sides of the arc portion 2421. The rotary shaft section 243 is inserted into and received in the insertion hole 313 of the exhaust cam 31, so that when the exhaust cam 31 drives the counterweight swing arm 22 to swing or oscillate, the counterweight swing arm 22 causes the depressurization cam element 24 to rotate by an angle. The rotary shaft section 243 is formed with a lubricant accommodation part 2431 that has a reduced diameter. The lubricant accommodation part 2431 is provided for receiving some oil to accumulate therein so as to reduce resistance against the rotation of the depressurization cam element 24 caused by the oil in case that the oil is excessively thick.

As shown in FIGS. 2, 6, 7, 8, and 9, to put the depressurization device 2 according to the present invention into use, before the internal combustion engine A is not started to operate, the arc portion 2421 of the depressurization cam section 242 of the depressurization cam element 24 of the depressurization device 2, as slightly projecting outward beyond the base circle section 312 of the exhaust cam 31, makes a pushing contact with the pushing peg 42 of the exhaust rocker arm 4, so as to set the exhaust valve in a slight opening state. After the internal combustion engine A is started, the counterweight swing arm 22 of the depressurization device 2 is caused to generate a centrifugal force with the rotation of the camshaft 3 so as to cause swinging about a swing center defined by the axle bar 25. When the counterweight swing arm 22 swings, the counterweight swing arm 22 causes the depressurization cam element 24 to rotate by an angle by means of the coupling pin 224, the depressurization cam element 24 is moved, through the rotation, to a position where the first cut-off portion 2422 and the second cut-off portion 2423 correspond and face the pushing peg 42 of the exhaust rocker arm 4. Since the first cut-off portion 2422 and the second cut-off portion 2423 is relatively lower than the arc portion 2421, the arc portion 2421 of the depressurization cam section 242 of the depressurization cam element 24 no longer pushes the pushing peg 42 of the exhaust rocker arm 4. Further, since the position-limiting block 225 of the counterweight swing arm 22 is received and located in the position-limiting slide chute 212 of the base disc 21, the counterweight swing arm 22 is constrained by the constraining sliding movement of the position-limiting block 225 in the position-limiting slide chute 212 of the base disc 21 so that a magnitude of swing of the counterweight swing arm 22 is constrained.

Following the description provided above, in an embodiment of the depressurization device 2 according to the present invention, the exhaust rocker arm 4 may not be provided with the pushing peg 42, before the internal combustion engine A is started and put into operation, the arc portion 2421 of the depressurization cam section 242 of the depressurization cam element 24 of the depressurization device 2 is in a condition of slightly projecting outward beyond the base circle section 312 of the exhaust cam 31 to thus provide a contact engagement with, and thus, push the pushing roller 41 of the exhaust rocker arm 4 to thereby set the exhaust valve in a slightly opening state, this also allowing an effect of depressurization to be activated at a low rotational speed of the internal combustion engine A.

The primary efficacy of the present invention is that the depressurization cam element 24 is formed of the driving section 241, the depressurization cam section 242, and the rotary shaft section 243 that are arranged in sequence in a direction from the counterweight swing arm 22 to the exhaust cam 31; the driving section 241 is formed with a fitting trough 2411, and the fitting trough 2411 receives the coupling pin 224 inserted in the through aperture 223 of the counterweight swing arm 22 to fit therein so that when the counterweight swing arm 22, after swinging, is returned by the spring force of the elastic element 23 to the original position, the counterweight swing arm 22 causes, by means of the coupling pin 224, the depressurization cam element 24 to rotate an angle; the depressurization cam section 242 includes the arc portion 2421 and the first cut-off portion 2422 and the second cut-off portion 2423 located at a side that is opposite to the arc portion 2421 and the outer edge 2421a of the arc portion 2421 receives a contact engagement of the pushing peg 42 of the exhaust rocker arm 4 to push thereon, so that before the exhaust cam 31 is put into pushing engagement with the exhaust rocker arm 4, the exhaust rocker arm 4 makes the exhaust valve open for a small degree and thus, an effect of depressurization can be initiated even at a low rotational speed of the internal combustion engine A to therefore ease starting and control a rotational speed for starting, and the internal combustion engine A is allowed to depressurize at a preset rotational speed to thereby enhance the effectiveness and universality of the depressurization device 2.

A second efficacy of the present invention is that the depressurization cam section 242 includes the arc portion 2421 and a third cut-off portion 2424 is further provided between the first cut-off portion 2422 and the second cut-off portion 2423 that are located at a side that is opposite to the arc portion 2421, so that a height between the opposite sides of the arc portion 2421 is effectively reduced to thereby enhance the effectiveness and universality of the depressurization device 2.

A third efficacy of the present invention is that the rotary shaft section 243 of the depressurization cam element 24 is provided with a lubricant accommodation part 2431 having a reduced diameter, so that the lubricant accommodation part 2431 may receive some oil to accumulate therein to reduce resistance against rotation of the depressurization cam element 24 caused by the oil in case that the oil is excessively thick to thereby ensure rotatability of the depressurization cam element 24.

A fourth efficacy of the present invention is that, as viewed in a radial direction, the depressurization cam section 242 is located outside a surface wide of the exhaust cam 31 and is arranged in a parallel manner, so that the service life of the exhaust cam 31 can be enhanced.

A fifth efficacy of the present invention is that a rotation center of the depressurization cam section 242 and a rotation center of the exhaust cam 31 are shifted away from each other and are arranged parallel, so that the service life of the exhaust cam 31 can be enhanced.

A sixth efficacy of the present invention is that the outer edge 2421a of the arc portion 2421 is arranged to project outward beyond the outer edge 312a of the base circle section 312 of the exhaust cam 31 by a height that is not greater than 0.9 mm, so that an effect of depressurization and an effect of noise reduction of the depressurization device 2 can be enhanced.

A seventh efficacy of the present invention is that the outer edge 2421a of the arc portion 2421 projects outward beyond the outer edge 312a of the base circle section 312 of the exhaust cam 31 by a height of approximately 0.1 mm to 0.8 mm, so that the depressurization device 2 has a bettered effect of depressurization.

An eighth efficacy of the present invention is that the outer edge 2421a of the arc portion 2421 projects outward beyond the outer edge 312a of the base circle section 312 of the exhaust cam 31 by a height of approximately between 0.6 mm and 0.8 mm, so that the depressurization device 2 has a bettered effect of noise reduction.

A ninth efficacy of the present invention is that the length L from the exhaust rocker arm pivot center of the exhaust rocker arm to the pushing roller rotation center is made less than the length L1 from the exhaust rocker arm pivot center to the pushing peg center, so that an effect of the exhaust rocker arm 4 pushing against the exhaust valve can be enhanced.

A tenth efficacy of the present invention is that the base disc 21 is formed as being integrally combined with the camshaft 3 and is located adjacent to the exhaust cam 31; and the base disc 21 is of a sector form, so that the overall weight of the base disc 21 is reduced and assembling of the depressurization device 2 is eased.

An eleventh efficacy of the present invention is that, as viewed in a radial direction, the depressurization cam section 242 is located outside a surface width of the exhaust cam 31 and is arranged in a parallel manner; the exhaust rocker arm 4 is provided, at an end thereof, with the pushing peg 42, so that the service life of the exhaust cam 31 is enhanced and the effectiveness and universality of the depressurization device 2 are improved.

I claim:

1. A depressurization device of an internal combustion engine, the depressurization device being mounted on a camshaft, the camshaft including an intake cam and an exhaust cam, the exhaust cam including a raised section and a base circle section, the exhaust cam being operable to push an exhaust rocker arm; the depressurization device comprising a base disc that is mounted on the camshaft and adjacent to the exhaust cam, a counterweight swing arm coupled to the base disc, an elastic element that is arranged between and hooks on the base disc and the counterweight swing arm, a depressurization cam element that is coupled to the exhaust cam and is drivable by the counterweight swing arm, and an axle bar that extends through and is received in the base disc and the counterweight swing arm, characterized in that the depressurization cam element comprises a driving section, a depressurization cam section, and a rotary shaft section that are arranged in sequence in a direction from the counterweight swing arm toward the exhaust cam; the depressurization cam element is drivable by the counterweight swing arm to rotate by an angle; and the depressurization cam section includes an arc portion and a first cut-off portion and a second cut-off portion that are arranged at a side that is opposite to the arc portion.

2. The depressurization device of the internal combustion engine according to claim 1, wherein the depressurization cam section includes the arc portion and a third cut-off portion located between the first cut-off portion and the second cut-off portion that are arranged at the side opposite to the arc portion.

3. The depressurization device of the internal combustion engine according to claim 1, wherein the rotary shaft section of the depressurization cam element is formed with a lubricant accommodation part that has a reduced diameter.

4. The depressurization device of the internal combustion engine according to claim 1, wherein, as viewed in a radial direction, the depressurization cam section is located outside a surface wide of the exhaust cam and is arranged in a parallel manner.

5. The depressurization device of the internal combustion engine according to claim 1, wherein a rotation center of the depressurization cam section and a rotation center of the exhaust cam are shifted away from each other and are arranged parallel.

6. The depressurization device of the internal combustion engine according to claim 1, wherein an outer edge of the arc portion projects outward beyond an outer edge of the base circle section of the exhaust cam by a height that is not greater than 0.9 mm.

7. The depressurization device of the internal combustion engine according to claim 6, wherein the outer edge of the arc portion projects outward beyond the outer edge of the base circle section of the exhaust cam by a height of approximately 0.1 mm to 0.8 mm.

8. The depressurization device of the internal combustion engine according to claim 6, wherein the outer edge of the arc portion projects outward beyond the outer edge of the base circle section of the exhaust cam by a height of approximately between 0.6 mm and 0.8 mm.

9. The depressurization device of the internal combustion engine according to claim 1, wherein a length from an exhaust rocker arm pivot center of the exhaust rocker arm to a pushing roller rotation center is less than a length from the exhaust rocker arm pivot center to a pushing peg center.

10. The depressurization device of the internal combustion engine according to claim 1, wherein the base disc is formed as being integrally combined with the camshaft and is located adjacent to the exhaust cam; and the base disc is of a sector form.

11. The depressurization device of the internal combustion engine according to claim 1, wherein as viewed in a radial direction, the depressurization cam section is located outside a surface width of the exhaust cam and is arranged in a parallel manner; and the exhaust rocker arm is provided, at an end thereof, with a pushing peg.
